(19) United States
(12) Patent Application Publication
(10) Pub. No.: US 2015/0286719 A1
(43) Pub. Date: Oct. 8, 2015

(54) RECOGNIZING AND REGISTERING FACES IN VIDEO

(71) Applicant: SONY CORPORATION, Tokyo (JP)

(72) Inventor: SRIRAM SAMPATHKUMARAN, San Diego, CA (US)

(73) Assignee: SONY CORPORATION, Tokyo (JP)

(21) Appl. No.: 14/244,155

(22) Filed: Apr. 3, 2014

(51) Int. Cl. G06F 17/30; G06F 3/0484

(52) U.S. Cl. CPC G06F 17/30831; G06F 3/04842

(57) ABSTRACT

A user can enter a name of one or more people to search in video or drag and drop around an image of a person or persons to be searched, and a computer tags video frames in which face recognition indicates that the person is present. All of the segments containing the person may be stitched together, omitting intervening segments not containing the person's image, or all segments with the person's image in them can be omitted and the remaining segments stitched together.

### I. FIELD OF THE INVENTION

The application relates generally to recognizing and registering faces in video.

### II. BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

### SUMMARY OF THE INVENTION

An example ecosystem that is pertinent here is an ecosystem in which video streams are available which may contain much content that a particular viewer may find uninteresting and may wish to summarize or condense to segments showing only people desired by the viewer to watch.

Accordingly, a computer device includes at least one computer readable storage medium bearing instructions executable by a processor, and at least one processor configured for accessing the computer readable storage medium to execute the instructions to configure the processor for receiving a query for at least one object in a video. The instructions when executed by the processor configure the processor for, based at least in part on the query, establishing a redacted version of the video.

In some embodiments, the redacted version includes frames containing an image of the object in the video. The redacted version may include only frames containing an image of the object in the video. In other embodiments, the redacted version includes only frames not containing an image of the object in the video.

In examples described below, the instructions when executed by the processor configure the processor for extracting frames in the video containing an image of the object in the video and not extracting frames in the video not containing an image of the object to establish a trick play file. The instructions when executed by the processor configure the processor for providing the trick play file for access thereof to respond to a trick play command during playback of the video.

In some implementations, the instructions when executed by the processor may configure the processor for, responsive to the query, extracting only every N^{th} I-frame in the video containing an image of the object in the video and extracting B-frames and P-frames associated with the every N^{th} I-frame in the video containing an image of the object in the video, wherein N is an integer greater than zero. In example embodiments, N is an integer greater than one and the instructions when executed by the processor can configure the processor for extracting at least a first I-frame intervening between an N^{th} I-frame containing an image of the object in the video and an N+2^{nd} I-frame containing an image of the object in the video regardless of whether the first I-frame contains an image of the object.

In another aspect, a method includes receiving a name of a person to search in video and/or a drag and drop around an image of a person to be searched in the video to establish a query. The method also includes, responsive to the query, tagging frames in the video in which face recognition indicates that an image of the person is present. The method includes stitching together segments in the video containing an image of the person while omitting intervening segments not containing an image of the person, or omitting all segments of the video containing an image of the person and stitching together remaining segments of the video.

In another aspect, a device includes at least one computer readable storage medium bearing instructions executable by a processor, and at least one processor configured for accessing the computer readable storage medium to execute the instructions to configure the processor for presenting, on a display, a user interface (UI) in turn presenting in a window a video and/or a still video frame from the video showing respective images of one or more persons. The instructions when executed by the processor configure the processor for prompting a user to enter into query field a name of a person or persons to search for to establish a query, and/or presenting on the UI a UI element for a user to drag and drop over an image of a person in the window to establish the query. The instructions when executed by the processor also configure the processor for enabling a user to select to generate a redacted version of the video from at least two redacted version options, based on the query.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIGS. 2 and 3 are flow charts of example logic according to present principles; and

FIG. 4 is a screen shot of an example user interface (UI) to allow a user to search video for people.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony PlayStation (trademarked), a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, Android, Java, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

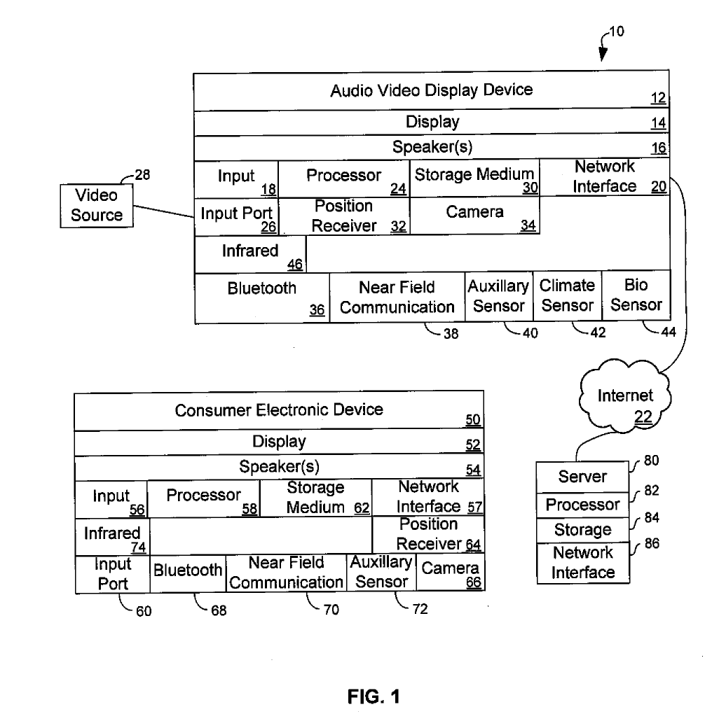

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may be touch-enabled for receiving user input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. When configured as, e.g., a HDMI port, the input port 26 may receive HDMI video from a video source 28 such as but not limited to a disk player, a personal video recorder, a game console, etc.

The AVDD 12 may further include one or more tangible computer readable storage medium 30 such as disk-based or solid state storage, in some cases embodied in the chassis of the AVDD as standalone devices or as a personal video recording device (PVR) or video disk player either internal or external to the chassis of the AVDD for playing back AV programs. Also in some embodiments, the AVDD 12 can include a position or location receiver such as but not limited to a cellphone receiver, GPS receiver and/or altimeter 32 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 34 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 36 and other Near Field Communication (NFC) element 38 for communication with other devices using Bluetooth and/or NFC technology, respectively. An example NFC element can be a radio frequency identification (RFID) element.

Further still, the AVDD 12 may include one or more auxiliary sensors 40 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include still other sensors such as e.g. one or more climate sensors 42 (e.g. barometers, humidity sensors, wind sensors, light sensors, temperature sensors, etc.) and/or one or more biometric sensors 44 providing input to the processor 24. In addition to the foregoing, it is noted that the AVDD 12 may also include an infrared (IR) transmitter and/or IR receiver and/or IR transceiver 46 such as an IR data association (IRDA) device. A battery (not shown) may be provided for powering the AVDD 12.

Still referring to FIG. 1, in addition to the AVDD 12, the system 10 may include one or more other CE device types such as the video source 28 which include components similar to some or all of the components in the AVDD described above. The example non-limiting CE devices may be established by any one of the above-mentioned devices, for example, a portable wireless laptop computer or notebook computer, a video disk player such as a Blu-ray player, a game console, a remote control (RC) for, e.g., issuing AV play and pause commands to the AVDD 12, or it may be a more sophisticated device such as a tablet computer, a wireless telephone, etc.

Accordingly, in addition to the video source 28, a first CE device 50 may include one or more displays 52 that may be touch-enabled for receiving user input signals via touches on the display. The first CE device 50 may include one or more speakers 54 for outputting audio in accordance with present principles, and at least one additional input device 56 such as e.g. an audio receiver/microphone for e.g. entering audible commands to the first CE device 50 to control the device 50. The example first CE device 50 may also include one or more network interfaces 57 for communication over the network 22 under control of one or more CE device processors 58. Thus, the interface 57 may be, without limitation, a Wi-Fi transceiver, which is an example of a wireless computer network interface. It is to be understood that the processor 58 controls the first CE device 50 to undertake present principles, including the other elements of the first CE device 50 described herein such as e.g. controlling the display 50 to present images thereon and receiving input therefrom. Furthermore, note the network interface 57 may be, e.g., a wired or wireless modem or router, or other appropriate interface such as, e.g., a wireless telephony transceiver, or Wi-Fi transceiver as mentioned above, etc.

In addition to the foregoing, the first CE device 50 may also include one or more input ports 60 such as, e.g., a HDMI port or a USB port to physically connect (e.g. using a wired connection) to another CE device and/or a headphone port to connect headphones to the first CE device 50 for presentation of audio from the first CE device 50 to a user through the headphones. The first CE device 50 may further include one or more tangible computer readable storage medium 62 such as disk-based or solid state storage. Also in some embodiments, the first CE device 50 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 50 is disposed in conjunction with the CE device processor 58. However, it is to be understood that that another suitable position receiver other than a cellphone and/or GPS receiver and/or altimeter may be used in accordance with present principles to e.g. determine the location of the first CE device 50 in e.g. all three dimensions.

Continuing the description of the first CE device 50, in some embodiments the first CE device 50 may include one or more cameras 66 that may be, e.g., a thermal imaging camera, a digital camera such as a webcam, and/or a camera integrated into the first CE device 50 and controllable by the CE device processor 58 to gather pictures/images and/or video in accordance with present principles. Also included on the first CE device 50 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 50 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 50 may include still other sensors such as e.g. one or more climate sensors (e.g. barometers, humidity sensors, wind sensors, light sensors, temperature sensors, etc.) and/or one or more biometric sensors providing input to the CE device processor 58. In addition to the foregoing, it is noted that in some embodiments the first CE device 50 may also include an infrared (IR) transmitter and/or IR receiver and/or IR transceiver 74 such as an IR data association (IRDA) device. A battery (not shown) may be provided for powering the first CE device 50. The CE device 50 may communicate with the AVDD 12 through any of the above-described communication modes and related components.

Additional CE devices in the ecosystem 10 may include some or all of the components shown for the CE device 50.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby. The server 80 may stream video to the AVDD 12 and/or CE device 50.

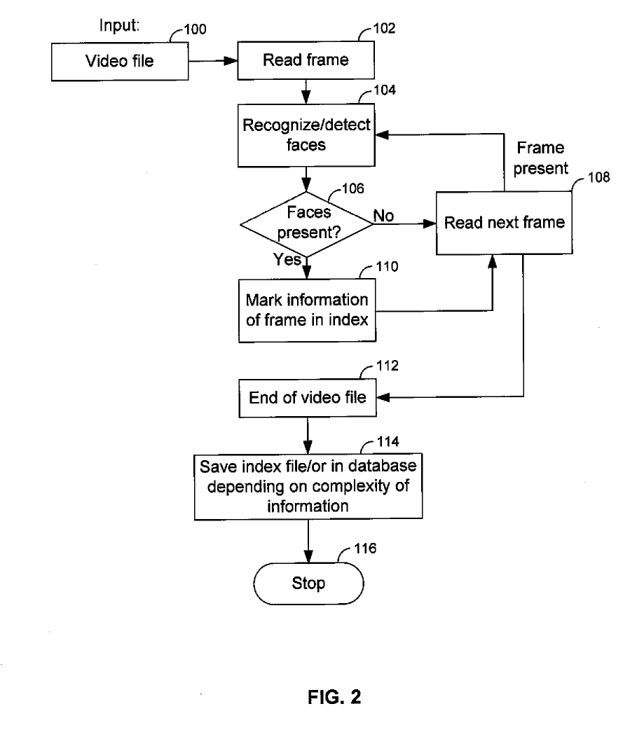

FIG. 2 shows example logic that may executed by the AVDD 12, alone or in concert with the processors of other devices in the network. At block 100, a video file is input to a processor executing instructions according to the example flow charts herein. The processor may be the AVDD processor 24 or it may be, for example, the server processor 82 operating, for instance, in parallel to the AVDD 12 presenting the video to a viewer. The video may be a hypertext transfer protocol (http)-formatted live stream from an Internet server, or from external inputs such as the video source 28, or from a TV tuner in or associated with the AVDD 12. Services that allow access to their video frames outside of the default player can be connected to a face recognition service and take advantage of logic herein.

At block 102, some or all of the frames (typically in motion picture experts group (MPEG) format) of the video are read. In some embodiments, only I-frames in MPEG are read at block 102. In other embodiments, only every N^{th} I-frame is read, where N is an integer greater than one. The frame number or identification is recorded for each read frame, and for each read frame, at block 104 objects such as human faces or types of consumer electronic devices are recognized using image recognition engines. For purposes of non-limiting explanation the discussion below assumes that the looked-for objects are people.

In recognizing faces in a video, faces initially may be given generic identifiers even if their proper names are not known, e.g., “face #1, face #2”, etc. so that a data structure may be created correlating frame numbers with recognized people throughout the video. Proper names may be accorded to recognized faces by user input or by searching the Internet for faces recognized in the video and locating matching images with proper names identifying them, then importing those proper names into the data structure and correlating them with the matching faces from the video. In establishing proper names by user entry, after processing as described herein a user interface (UI) may be presented to the user showing the M faces in the video (M being an integer) along with the generic names, e.g., “face #1, face #2,”, etc., inviting the user to enter a proper name for each face in a name entry field and then correlating the entered names in the database with the associated faces. Potential faces in the video may also be so identified prior to processing the video.

Decision diamond 106 indicates that for each read frame, it is determined whether any faces are present, and if not a next frame is read at block 108, unless the end of the video has been reached in which case the logic loops to block 112. However, if faces are recognized, the logic moves from decision diamond 106 to block 110 to add frame information including the frame identification/location in the video and any faces recognized therein in a data structure such as an index. A next frame is read at block 108, unless the end of the video has been reached in which case the logic loops to block 112, from which the logic proceeds to block 114 to save the data structure (e.g., the index or a database) and end at state 116.

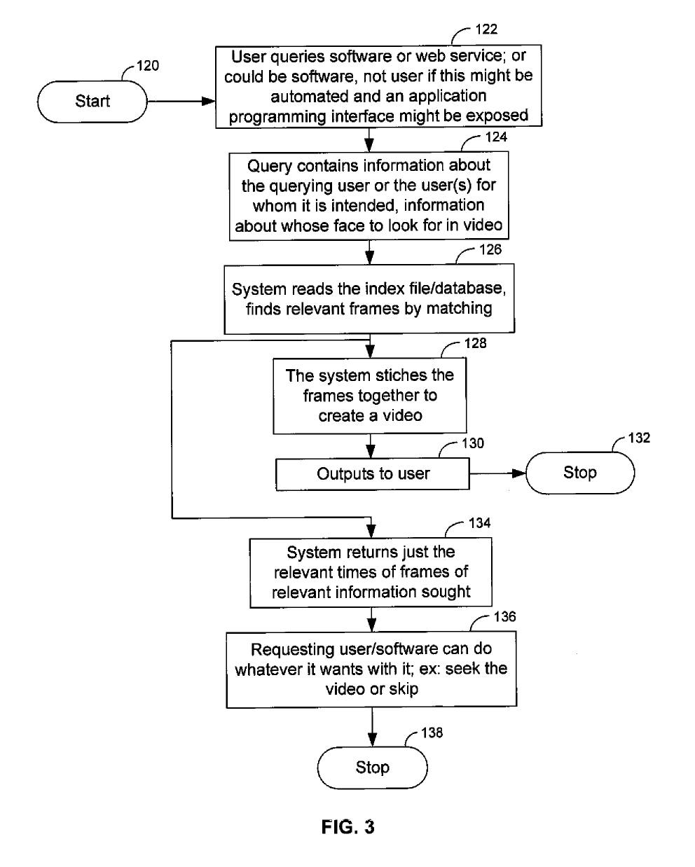

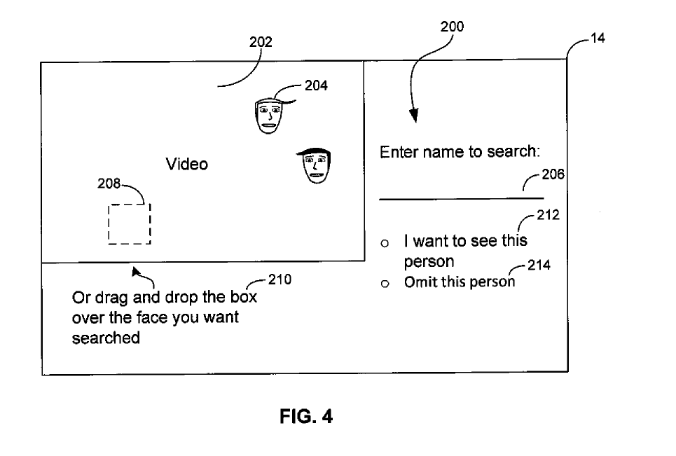

FIG. 3 shows example logic that may be executed once video has been indexed with frame identifiers and associated face identifications in FIG. 2. Starting at state 120, the logic moves to block 122 to receive a query of the indexing processor (if local) or web-hosted service (if remote) related to the video. Note that the query may be human-input or may be automatically input post-FIG. 2 processing by, e.g., an application programming interface (API). In any case, block 124 indicates that the query can indicate information about the querying user (e.g., user credential information and a query result destination network address to which the output of query execution is to be sent) as well as an identification of the desired face or faces recognized in the video and indexed or otherwise stored by the logic of FIG. 2. FIG. 4, described further below, illustrates non-limiting examples of how a user might input a desired face as part of the query.

In response to the query, at block 126 the executing processor accesses the data structure configured by the logic of FIG. 2 to extract the frames containing the queried-for face. In one example, the logic moves to block 130 to stitch the extracted frames together (along with any intervening frames between extracted frames, including P-frames, B-frames, and any I-frames not read in FIG. 2) in temporal order as indicated by frame identification data in the data structure to output a redacted video to the query result destination address at block 130, ending at state 132. Thus, the redacted video in this case is the original video minus segments not containing the queried-for face.

Or, only the extracted frames without intervening frames may be extracted and returned to the querying computer at block 134 so that the extracted frames may be processed at block 136 by the query result destination computer may employ the extracted frames in various ways, with the logic in this branch ending at state 138. As an example, the extracted frames at the query result destination computer may be stored in a trick play file that is synchronized with the full video. During play of the full video, the trick play file can be accessed in response to various trick play commands at the extracted frame temporally closest to the current location of the full video to execute the trick play command. For example, a user can select a “skip” input element on a playback control and the computer accesses the trick play file, finds the extracted frame closest in the future to the current location of the full video, and using the frame identification of extracted frame in the trick play file, skips play of the current full video to the frame in the full video matching the identification of the extracted frame closest in the future to the current location of the full video. Or, a user can select a “seek” input element and enter a name of a face in frames of the trick play file, and in response the computer can employ the trick file to seek forward (or back, depending on the direction of the user command) in the full video to the closest frame showing the sought-for face according to principles above and resume play of the full video from that point.

As yet another alternative to the embodiments described above, present principles recognize that a user may wish to omit a particular face (person) from a redacted version of the full video. In this case, at block 128, instead of stitching together the frames with the user-identified face in them to produce a redacted version of the full video, the computer omits those frames and stitches together the remaining frames to establish the redacted version of the video.

FIG. 4 illustrates an example UI 200 that may be presented on a device such as the display 14 of the AVDD 12 shown in FIG. 1. Video or a video frame may be presented in a window 202 showing one or more faces 204. As shown in FIG. 4, a user can be prompted to enter into query field 206 a name of a person or persons to search for, essentially to establish the query at block 122 of FIG. 3. Alternatively, a UI element such as a box 208 may be presented in the window 202 and the user prompted at 210 to drag and drop the box over the face of the desired person to search for in the video, to cause the query to be executed by searching for computer-designated generic name as described above. The user can select at 212 to generate a redacted version of the full video showing only segments containing the designated person. Or, the user can select at 214 to generate a redacted version of the full video showing only segments not containing the designated person.

As understood herein, recognizing that there are faces in a video stream can help to identify frames as relevant or not relevant, and help in searching video content for a particular face. Additional applications are afforded in information retrieval, security, personal memories. For example, while playing back a video of a lecture, students might want to skip to the time when a particular professor or guest speaker walks in rather than finding that manually. The user is enabled to skip or seek scenes that have or do not have faces or a particular face. Summary/shorter redacted versions of videos may be programmatically created with just the relevant content that can be tailored to a particular user. For example: take a long video of a particular event and two people with different tastes. A different summary video could be created for both of them based on the different faces the users identify.

While the particular RECOGNIZING AND REGISTERING FACES IN VIDEO is herein shown and described in detail, it is to be understood that the subject matter which is encompassed by the present invention is limited only by the claims.

What is claimed is:

1. A computer device comprising:
at least one computer readable storage medium bearing instructions executable by a processor;
at least one processor configured for accessing the computer readable storage medium to execute the instructions to configure the processor for:
receiving a query for at least one object in a video; and
based at least in part on the query, establishing a redacted version of the video.

2. The device of claim 1, wherein the redacted version includes frames containing an image of the object in the video.

3. The device of claim 1, wherein the redacted version includes only frames containing an image of the object in the video.

4. The device of claim 1, wherein the redacted version includes only frames not containing an image of the object in the video.

5. The device of claim 1, wherein the instructions when executed by the processor configure the processor for:
extracting frames in the video containing an image of the object in the video and not extracting frames in the video not containing an image of the object to establish a trick play file;
providing the trick play file for access thereof to respond to a trick play command during playback of the video.

6. The device of claim 1, wherein the instructions when executed by the processor configure the processor for:
responsive to the query, extracting only every N^{th} I-frame in the video containing an image of the object in the video and extracting B-frames and P-frames associated with the every N^{th} I-frame in the video containing an image of the object in the video, wherein N is an integer greater than zero.

7. The device of claim 6, wherein N is an integer greater than one and the instructions when executed by the processor configure the processor for:
extracting at least a first I-frame intervening between an N^{th} I-frame containing an image of the object in the video and an N+2^{nd} I-frame containing an image of the object in the video regardless of whether the first I-frame contains an image of the object.

8. Method, comprising:
receiving a name of a person to search in video or a drag and drop around an image of a person to be searched in the video to establish a query;
responsive to the query, tagging frames in the video in which face recognition indicates that an image of the person is present;
stitching together segments in the video containing an image of the person while omitting intervening segments not containing an image of the person, or omitting all segments of the video containing an image of the person and stitching together remaining segments of the video.

9. The method of claim 8, comprising stitching together segments in the video containing an image of the person while omitting intervening segments not containing an image of the person.

10. The method of claim 8, comprising omitting all segments of the video containing an image of the person and stitching together remaining segments of the video.

11. The method of claim 8, comprising:
extracting frames in the video containing an image of the person to establish a trick play file;
providing the trick play file for access thereof to respond to a trick play command during playback of the video.

12. The method of claim 8, comprising:
responsive to the query, extracting only every N^{th} I-frame in the video containing an image of the person and extracting B-frames and P-frames associated with the every N^{th} I-frame in the video containing an image of the person, wherein N is an integer greater than zero.

13. The method of claim 12, wherein N is an integer greater than one and the method comprises:
extracting at least a first I-frame intervening between an N^{th} I-frame containing an image of the person and an N+2^{nd} I-frame containing an image of the person regardless of whether the first I-frame contains an image of the person.

14. A device comprising:
at least one computer readable storage medium bearing instructions executable by a processor;
at least one processor configured for accessing the computer readable storage medium to execute the instructions to configure the processor for:
presenting on a display a user interface (UI) presenting in a window a video and/or a still video frame from the video showing respective images of one or more persons;
prompting a user to enter into query field a name of a person or persons to search for to establish a query, and/or presenting on the UI a UI element for a user to drag and drop over an image of a person in the window to establish the query; and
enabling a user to select to generate a redacted version of the video from at least two redacted version options, based on the query.

15. The device of claim 14, wherein the instructions when executed by the processor configure the processor for prompting a user to enter into query field a name of a person or persons to search for to establish a query.

16. The device of claim 14, wherein the instructions when executed by the processor configure the processor for presenting on the UI a UI element for a user to drag and drop over an image of a person in the window to establish the query.

17. The device of claim 14, wherein a first redacted version option includes frames containing an image of the person in the video.

18. The device of claim 14, wherein a first redacted version option includes only frames containing an image of the person in the video.

19. The device of claim 14, wherein a first redacted version option includes only frames not containing an image of the person in the video.

20. The device of claim 14, wherein the instructions when executed by the processor configure the processor for:
extracting frames in the video containing an image of the person in the video and not extracting frames in the video not containing an image of the person to establish a trick play file;
providing the trick play file for access thereof to respond to a trick play command during playback of the video.
